(19) United States
(12) Patent Application Publication
(10) Pub. No.: US 2022/0122474 A1
(43) Pub. Date: Apr. 21, 2022

(54) Spinning 3D Geometric Shapes

(71) Applicant: Lawrence W. Hush, Silver Spring, MD (US)

(72) Inventor: Lawrence W. Hush, Silver Spring, MD (US)

(21) Appl. No.: 17/504,637

(22) Filed: Oct. 19, 2021

Related U.S. Application Data
(60) Provisional application No. 63/224,587, filed on Jul. 22, 2021.
(60) Provisional application No. 63/093,490, filed on Oct. 19, 2020.

(51) Int. Cl. G09B 1/18; A63H 1/00

(52) U.S. Cl. CPC G09B 1/18; A63H 1/00

(57) ABSTRACT

The present invention relates to a kit used for educational and fun purposes that provides components for creating and visualizing complex geometrical shapes. The kit includes small spheres and pegs that can be assembled into multiple geometric shapes, such as polyhedrons. The shapes are created from separate spheres used as vertices that are connected using pegs. Inner spheres including two holes are placed inside the pegs wherein the holes are used for rotating the shapes both horizontally and vertically. A stand includes horizontal spinning rods and vertical rods that are used for rotating the shapes to enable students to visualize and understand the shapes from all angles. The shapes can be assembled and disassembled as per the preferences of a student. The outer spheres, pegs and inner spheres are manipulable parts that provide hours of fun and learning and help students to learn different aspects of geometry.

### CROSS-REFERENCE TO RELATED APPLICATION

The present application claims priority to, and the benefit of, U.S. Provisional Application No. 63/224,587, which was filed on Jul. 22, 2021, and U.S. Provisional Application No. 63/093,490, which was filed on Oct. 19, 2020, both of which are incorporated herein by reference in their entirety.

### FIELD OF THE INVENTION

The present invention relates generally to the field of educational toys. More specifically, the present invention relates to an educational toy kit that provides components including small spheres and pegs that can be assembled into multiple geometric shapes such as polyhedrons. The shapes are created from separate wooden spheres used as vertices that are connected using pegs. Inner spheres including two holes are placed inside the pegs wherein the holes are used for rotating the shapes both horizontally and vertically on a stand including horizontal spinning rods and vertical rods. The shapes can be assembled and disassembled as per the preferences of a player, child, or student. The spheres, pegs, and inner spheres include manipulable parts that provide hours of fun, building, and learning and helps students to learn different aspects of geometry. Accordingly, the present disclosure makes specific reference thereto. Nonetheless, it is to be appreciated that aspects of the present invention are also equally applicable to other like applications, devices, and methods of manufacture.

### BACKGROUND

Mathematics is an exciting subject for children of all ages and helps to develop brain activity, creativity and analytical skills. Mathematics helps individuals understand the world and provides an effective way of building mental discipline while encouraging logical reasoning, critical thinking, spatial thinking, and/or problem-solving ability. Geometry is a branch of mathematics that deals with geometric shapes. Studying geometry helps students improve logic, problem solving, and deductive reasoning skills. In geometry, simple shapes are easy to understand and visualize even in two-dimensions, such as when drawn on a board or on a paper. However, more complex shapes such as polyhedrons, including three-dimensional shapes with flat polygonal faces, straight edges and sharp corners or vertices are hard to visualize and understand when shown or drawn on a piece of paper. Teachers and other educators desire to demonstrate these complex shapes in a three-dimensional (3D) manner such that the shapes can be visible from different angles and views enabling the students and other individuals to understand the intricacies of these complex shapes.

Students who study geometry face the issue in understanding these abstract shapes without any tangible visual aids. For relatively younger children, understanding these shapes is important as they can become intellectually enlightened upon learning and understanding these shapes.

Teachers may use solid geometric teaching aids with students. Conventional solid geometric teaching aids allow children to build and/or create configurations and/or structures. However, conventional solid geometric teaching aids are useful for simple shapes but are ineffective for complex shapes that contain many faces, edges and vertices. Further, these solid geometric teaching aids are not available as a toy, and especially as a spinning toy, that can act as a functional model for understanding complex shapes. Heretofore known teaching aids are hard for children to manipulate the shapes and/or to build new shapes, and this can cause frustration in children. Frustration can lead to a loss of interest in mathematics, and especially geometry.

Therefore, there exists a long felt need in the art for an improved tangible functional model aid that provides a functional and tactile model for visualizing and manipulating complex geometric shapes. There is also a long felt need in the art for an improved tangible functional model aid that can be assembled into a plurality of shapes, such as multiple polyhedrons. Additionally, there is a long felt need in the art for an improved tangible functional model aid that enables students to understand different faces, sides, vertices and their interrelated relationship in a complex geometric shape. Moreover, there is a long felt need in the art for an improved tangible functional model aid that enables students to hold and spin the faces, vertices and edges of the various shapes for a complete understanding and visualization of a geometric shape. Furthermore, there is a long felt need in the art for an improved tangible functional model aid that can be used by educators for teaching geometry effectively. Finally, there is a long felt need in the art for an improved tangible functional model aid that can be used by both educators and students to understand how different aspects of geometry are related in a fun manner.

The subject matter disclosed and claimed herein, in one embodiment thereof, comprises a kit for creating and visualizing complex 3D shapes. The kit includes a plurality of small spheres used as vertices, a plurality of pegs for connecting the spheres to form the 3D shape and a plurality of inner spheres wherein one or more inner spheres are placed at the center of the 3D shape. The kit also includes a stand including at least one horizontal rod and at least one vertical rod that enables the created 3D complex shape to be mounted in order to allow horizontal or vertical rotation of the mounted 3D shape. The vertical and the horizontal rotation enables users such as students and children to hold and spin the faces, vertices and edges of the 3D shapes for visualization, understanding, and entertainment from all angles.

In this manner, the improved polyhedron-like spinner device of the present invention accomplishes all of the forgoing objectives and provides a multi-purpose, convenient and easy solution that offers a way to visualize and understand complex geometric 3D shapes. The device includes manipulable components that can be assembled and disassembled for use by children for hours of fun. The components enable building and learning by creating complex geometric shapes such as tetrahedrons, hexahedrons, octahedrons and more. The device enables students and children to hold and spin the faces, vertices, and edges of the various shapes around the dowels so that they can be visualized and understood from all angles.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a kit for creating and visualizing complex 3D shapes. The kit includes a plurality of small spheres used as vertices, a plurality of pegs for connecting the spheres to form the 3D shapes and a plurality of inner spheres wherein one or more inner spheres are placed at the center of the 3D shapes. The kit also includes a stand, including at least one horizontal rod and at least one vertical rod wherein the created 3D complex shape can be mounted to the horizontal rod for vertical rotation of the 3D shape and can also be mounted to the vertical rod for horizontal rotation of the 3D shape. The vertical and the horizontal rotation enables users such as students to hold and spin the faces, vertices and edges of the 3D shapes for visualization and understanding from all angles.

In one potential embodiment, the small spheres can be about 1¼″ in diameter and can be used as vertices of 3D shapes. The pegs can be about 3/16″ diameter dowel rods and can be used as edges. It is to be appreciated that any variety of different dimensions can be used in the present invention. In yet other potential embodiments, the 3D shapes can be one or more of a tetrahedron, a hexahedron, an octahedron, a dodecahedron, an icosahedron or more.

In yet another potential embodiment of the present invention, each of the inner spheres can include two ¼″ holes wherein a first hole extends completely through the inner sphere enabling the 3D shape in which the inner sphere is placed to mount to a horizontal rod of the stand and the second hole extends only halfway through the inner sphere enabling the 3D shape in which the inner sphere is placed to mount to the vertical rod.

It is also disclosed that the kit of the present invention also includes a two-sphere spinner shape with a sphere that can be cut into 8 equal sections, reconnected with pegs with an internal sphere that enables for spinning.

In yet another embodiment of the present invention, a wooden stand for mounting a polyhedron shape is disclosed. The wooden stand includes at least a pair of horizontal spinning rods and at least a pair of vertical rods. Each horizontal spinning rod can be supported by a plurality of vertically-oriented supporting bars or rods. The horizontal spinning rods and the vertical supporting rods can be used for mounting complex polyhedron shapes, wherein each horizontal spinning rod is configured to rotate the mounted polyhedron in a generally vertical direction and each vertical rod is configured to rotate the mounted polyhedron in a generally horizontal direction.

In yet another embodiment, a method for visualizing and understanding complex geometric shapes by rotating the shapes horizontally and vertically is described. The method includes the steps of initially creating a complex geometric shape using spheres, pegs and inner spheres, wherein the geometric shape is created by connecting the spheres using the pegs and placing the inner spheres at the center of the complex geometric shape, then mounting the created geometric shape on a horizontal spinning rod for a first rotation of the shape and thereafter mounting the geometric shape on a vertical rod for a second rotation. The first and the second rotations enable students to hold and spin the faces, vertices, and edges of the various shapes so that they can be visualized and understood from all angles.

In yet another embodiment of the present invention, the first rotation is the vertical rotation, and the second rotation is the horizontal rotation.

The present invention is employed to enable students to understand how different aspects of geometry are related, and features a stand to view shapes from all faces, edges and vertices. The invention provides components that can be used for creating tetrahedrons, hexahedrons, octahedrons, and more, and offers a plurality of manipulable parts for hours of fun, building and learning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a single polyhedron-like spinner device kit of the present invention in accordance with the disclosed architecture;

FIG. 2 illustrates a perspective view of an exemplary shape of the assembled spinner device of the present invention in the form of a two-sphere or dual-sphere spinner in accordance with the disclosed architecture;

FIG. 3 illustrates a perspective view of an exemplary assembled tetrahedron created using the kit of the present invention in accordance with the disclosed architecture;

FIG. 4 illustrates a perspective view showing how different assembled shapes of spinner devices are placed on the horizontal rods and vertical rods of the stand in accordance with the disclosed architecture;

FIG. 5 illustrates a flow diagram showing exemplary steps performed for rotating a shape both horizontally and vertically enabling students to visualize and understand the shape from all angles in accordance with the disclosed architecture; and

FIG. 6 illustrates a perspective view showing a student playing with the assembled shapes using the kit of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved tangible functional model aid that provides a functional and tactile model for visualizing and manipulating complex geometric shapes. There is also a long felt need in the art for an improved tangible functional model aid that can be assembled into a plurality of shapes such as multiple polyhedrons. Additionally, there is a long felt need in the art for an improved tangible functional model aid that enables students to understand different faces, sides, vertices, and their interrelated relationships in a complex geometric shape. Moreover, there is a long felt need in the art for an improved tangible functional model aid that enables students to hold and spin the faces, vertices, and edges of the various shapes for a complete understanding and visualization of a geometric shape. Faces include the flat or curved surfaces that make up the outside, or outer periphery, of a 3D shape. Edges include the lines where two faces of a 3D shape meet. Vertices include the corners of a 3D shape formed where two or more edges meet. Furthermore, there is a long felt need in the art for an improved tangible functional model aid that can be used by educators for teaching geometry effectively. Finally, there is a long felt need in the art for an improved tangible functional model aid that can be used by both educators and students to understand how different aspects of geometry are related in a fun manner.

The present invention, in one exemplary embodiment, is a novel method for visualizing and understanding complex geometric shapes by rotating the same both horizontally and vertically is disclosed. The method includes the steps of creating a complex geometric shape using spheres, pegs and inner spheres. Then, the created complex geometric shape can be mounted on a horizontal spinning rod for a first-oriented rotation of the shape and/or can be mounted on a vertical rod for a second-oriented rotation. The first and the second-oriented rotations enable students to hold and spin the faces, vertices and edges of the various shapes so that they can be visualized and understood from all angles.

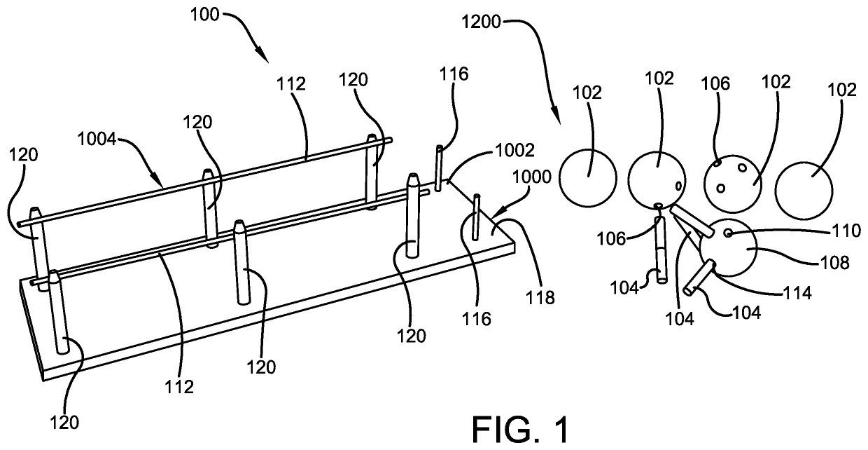

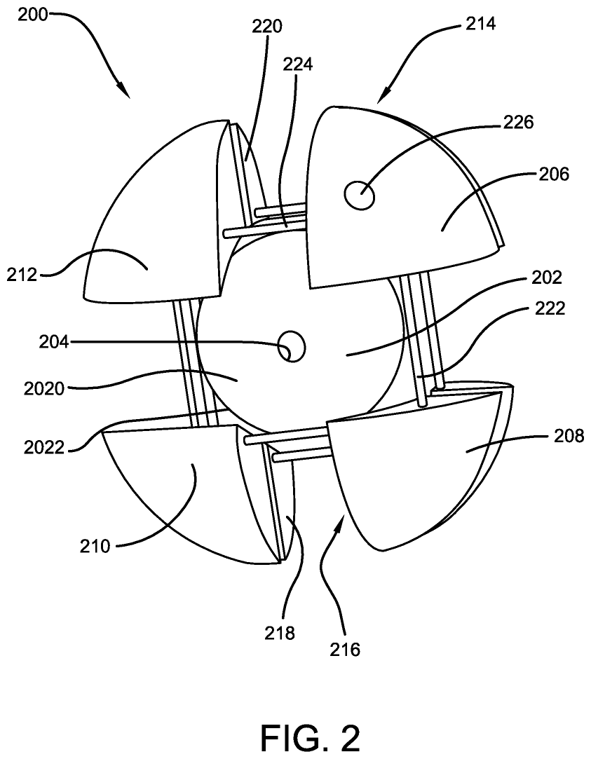

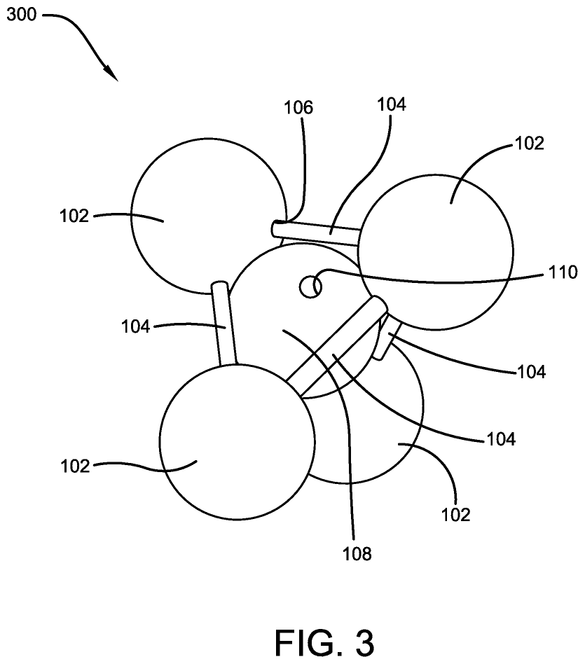

Referring initially to the drawings, FIG. 1 illustrates a perspective view of one potential embodiment of a single polyhedron-like spinner device kit of the present invention in accordance with the disclosed architecture. The polyhedron-like spinner device kit 100 of the present invention can be available in the form of a kit that includes a plurality of components or parts 1200 that can be assembled to form an overall design of a spinning assembly as exemplary shown in FIGS. 2 and 3. The kit 100 can also include a stand 1004 on which the assembled spinning assembly can be mounted for generally horizontal and vertical spinning. The parts 1200 can be manipulable and can be assembled to form different types of polyhedrons such as, a tetrahedron, a hexahedron and an octahedron. The parts 1200 can also be assembled to form complicated polyhedron shapes, such as a dodecahedron, an icosahedron and more. More specifically, the components 1200 include a plurality of small spheres 102 that can be used as vertices of a polyhedron. In one embodiment, each sphere 102 can be about 1¼″ in diameter and the spheres 102 can be connected to each other using pegs 104 which are in the form of generally 3/16″ diameter dowel rods. The pegs 104 can be used as edges of the polyhedron formed by spheres 102. The spheres 102 can be available in a plurality of colors and can include at least two openings 106, thereby enabling the pegs 104 to partially extend through the sphere 102. The components 1200 can have virtually any shape and size, and the material composition can comprise a material selected from a group consisting of a wood, a plastic, a rubber or any other durable material.

A special inner sphere 108 is used for placement inside the pegs 104 and can be positioned at the center of an assembled spinner device. The inner sphere 108 incudes a first hole 110 that extends through the sphere 108 enabling a horizontal spinning rod 112 positioned on a base 1000 to pass through the inner sphere 108. The spinner device in an assembled form can spin around the longitudinal axis of the horizontal rod 112. This rotation enables a child to view different faces, vertices and edges of the device 100 to understand how different aspects of geometry are related in the assembled spinner device. The components 1200 can be disassembled to form a new and different type of polyhedron.

The inner sphere 108 can also include a second ¾″ hole 114 that extends only halfway through the inner sphere 108. The second ¼″ hole 114 is used for positioning the polyhedron spinner device 100 on a vertical rod 116 positioned on the base 1000. In one potential embodiment, the vertical rod 116 is positioned on one end 1002 of the base 1000.

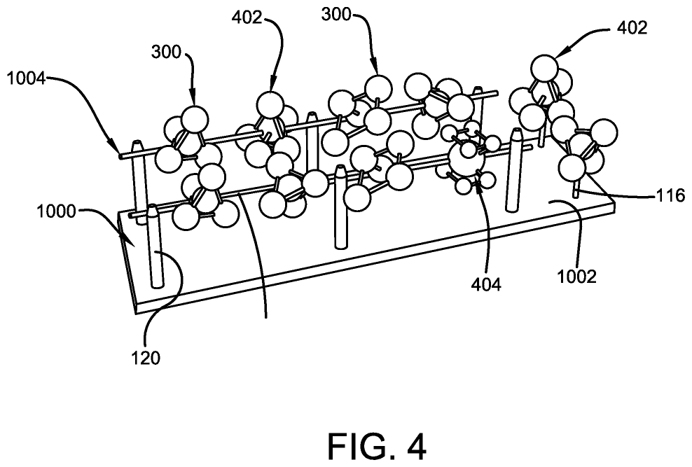

The horizontal rod 112 is supported on a plurality of supporting bars 120 that can be placed equidistantly on the base 1000 such that the supporting bars 120 are used for horizontally and detachably-placing the horizontal rod 112 thereto. A plurality of assembled spinner devices, in the form of various types of polyhedrons, can be placed along the horizontal spinning rod 112, using the central first hole 110 of the inner sphere 108 as shown in FIG. 4.

The base 1000, including the vertical supporting bars 120 and a pair of vertical rods 116, enables a child to rotate the assembled spinning polyhedron in both horizontal and vertical directions for viewing the polyhedron shapes from all faces, edges and vertices.

The components 1200 comprising the spheres 102, the pegs 104 and the inner sphere 108 can be used for assembling shapes like a tetrahedron (4 faces and 4 vertices), a hexahedron (6 faces and 8 vertices), or an octahedron (8 faces and 6 vertices), a dodecahedron (12 faces and 20 vertices), an icosahedron (20 faces and 12 vertices) and many more complex shapes. It is to be appreciated that vertices represent corners of the polyhedron, and faces represent single flat surfaces or planes. Each shape, after assembling, can be hung on the horizontal rod 112 or the vertical rods 116 for rotation.

FIG. 2 illustrates a perspective view of an exemplary shape of the assembled spinner device of the present invention in the form of a two-sphere spinner 200 in accordance with the disclosed architecture. The present embodiment of the spinner device is in the form of a two-sphere spinner 200. The two-sphere spinner 200 includes a central sphere 202 including a hole 204 through which the horizontal rod or the vertical rod of the stand as shown in FIG. 1 can pass, thereby enabling the two-sphere spinner 200 to rotate in a horizontal or vertical direction. Four quadrants 206, 208, 210, 212 are positioned on front side 2020 of the sphere 202 and similarly four quadrants 214, 216, 218, 220 are positioned on rear side 2022 of the sphere 202. Each of the adjacent quadrants are connected through pegs for providing a durable shape. As shown, the first quadrant 206 is connected to adjacent quadrants 208 using the peg 222, quadrant 212 using the peg 224, and to the first opposing quadrant 214 using the peg 226. Similarly, other quadrants are connected through the respective pegs in a similar manner and are not described hereinafter for brevity purposes. Specifically, each quadrant is connected to three adjacent quadrants through three pegs and the connections are detachable and can be removed to reshape the two-sphere spinner 200 or for making a new shape using the quadrants, sphere, pegs and other components available in the kit of the present invention.

FIG. 3 illustrates a perspective view of an exemplary assembled tetrahedron created using the kit of the present invention in accordance with the disclosed architecture. The present embodiment of the spinner device is in the form of a tetrahedron 300 that can be created using components 1200 described in FIG. 1. The tetrahedron 300 includes four vertices shown through the spheres 102 that are connected through pegs 104 shown as edges connecting the vertices. The four vertices and the connecting edges form the basic tetrahedron shape that can be formed in various colors and sizes. The pegs 104 can be inserted into the holes 106 disposed on the spheres 102 for a secure connection between the spheres 102. A central inner sphere 108 is disposed that can include two ¾″ diameter holes. As shown, the hole 110 extends completely through the central inner sphere 108, thereby enabling the tetrahedron 300 to be mounted on horizontal spinning rods 112 shown in FIG. 1 for rotation to see edges, vertices and faces from various angles. The inner sphere 108 includes a second hole (not shown) that extends halfway through the inner sphere 108, thereby enabling the inner sphere 108 to mount to one of the vertical rods 116 of the base 1000 enabling the tetrahedron 300 to rotate horizontally. The tetrahedron 300 is merely shown as an example and various complex 3D shapes, such as hexahedron (6 faces, 8 vertices, and cuboidal) or an octahedron (8 faces and 6 vertices) and more complicated polyhedron shapes, such as a dodecahedron (12 faces and 20 vertices), an icosahedron (20 faces and 12 vertices) or other even more challenging shapes can be created and assembled using the components 1200.

FIG. 4 illustrates a perspective view showing how different assembled shapes of spinner devices are placed on dual horizontal rods and multiple vertical rods of an exemplary stand 1004 in accordance with the disclosed architecture. As shown, a plurality of spinner device shapes, such as tetrahedron 300, hexahedron 402, octahedron 404 and others in assembled form are mounted on the horizontal rods 112 and the vertical rods 116 for rotation, thereby enabling the users to view different faces, vertices and edges of the shapes. The shapes can be easily mounted and removed from both the horizontal rods 112 and the vertical rods 116 of the base 1000. The base 1000 can comprise a material of a wood, a plastic, a metal or any other durable material. The base 1000 can include a logo, a design and/or an indicia and can come in various colors and sizes.

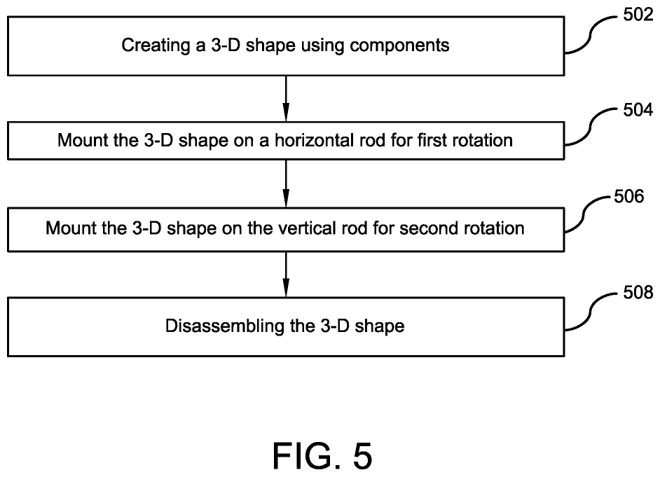

FIG. 5 illustrates a flow diagram showing exemplary steps performed for rotating a shape both horizontally and vertically, enabling students to visualize and understand the shape from all angles in accordance with the disclosed architecture. It should be understood that the present embodiment states the basic flow performed by a user and additional actions may be used to add additional processes to the basic flow. Initially, a desired 3D shape is created by a user or a student using the components such as spheres, inner sphere, pegs and more (Block 502). Then, the assembled or created 3D shape is mounted on one of the horizontal rods of the stand for vertical rotation about the hole of the inner sphere for visualizing and understanding the shape from all angles (Block 504). Thereafter, the 3D shape can be removed from the horizontal rod and then mounted on one of the vertical rods of the stand for horizontal rotation along a second hole of the inner sphere for visualizing and understanding the shape from other angles (Block 506). Finally, after understanding the shape and its features, the 3D shape can be disassembled by the student (Block 508).

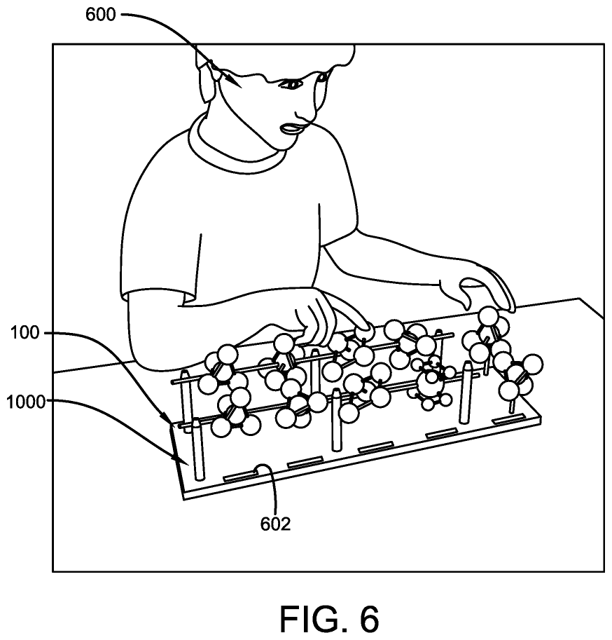

FIG. 6 illustrates a perspective view showing a student playing with the assembled shapes using the kit 100 of the present invention in accordance with the disclosed architecture. As shown, a student 600 can play with the different shapes mounted on the base 1000 of the kit 100 for visualizing the shapes by rotating them vertically and horizontally. Further, the base 1000 can have the identification diagrams or tags 602 of various shapes enabling the student 600 to understand and correlate the shapes. The diagrams 602 can be detachable or can be permanent as well.

Additionally, it should also be noted that a more complicated and therefore more interesting spinner is created by placing the two-sphere spinner inside the polyhedron, in place of the single inner sphere. This creates a three-level spinner.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “polyhedron-like spinner device kit”, “polyhedron spinner device” and “kit” are interchangeable and refer to the polyhedron-like spinner device kit 100 of the present invention.

Notwithstanding the forgoing, the polyhedron-like spinner device kit 100 of the present invention can be of any suitable size and configuration as is known in the art without affecting the overall concept of the invention, provided that it accomplishes the above-stated objectives. One of ordinary skill in the art will appreciate that the size, configuration and material of the polyhedron-like spinner device kit 100 as shown in the FIGS. are for illustrative purposes only, and that many other sizes and shapes of the polyhedron-like spinner device kit 100 are well within the scope of the present disclosure. Although the dimensions of the polyhedron-like spinner device kit 100 are important design parameters for user convenience, the polyhedron-like spinner device kit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments including different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A polyhedron spinner device kit comprising:
a plurality of buildable components comprising a plurality of outer spheres, an inner sphere and a plurality of pegs;
wherein said inner sphere comprises a first central hole extending therethrough, a second hole extending partially therethrough, and a third hole partially extending therethrough;
wherein said plurality of outer spheres include a plurality of holes;
wherein said plurality of pegs are insertable into said plurality of holes of said plurality of outer spheres to connect at least four of said plurality of outer spheres spaced around said inner sphere;
wherein said inner sphere is selectively mountable to a horizontal rod with said first central hole or to a vertical rod with said second hole; and
at least one peg connected to said third hole of said inner sphere and to at least one of said plurality of holes of at least one of said plurality of outer spheres for connecting said plurality of outer spheres to said inner sphere to form a geometric shape therearound.

2. The polyhedron spinner device kit of claim 1, wherein said plurality of outer spheres comprise at least six outer spheres.

3. The polyhedron spinner device kit of claim 1, wherein said plurality of outer spheres comprise at least eight outer spheres.

4. The polyhedron spinner device kit of claim 1, wherein said plurality of outer spheres comprise at least twelve outer spheres.

5. The polyhedron spinner device kit of claim 1, wherein said plurality of outer spheres comprise at least twenty outer spheres.

6. The polyhedron spinner device kit of claim 1, wherein said inner sphere is rotatable about said horizontal rod for viewing of said geometric shape in a first rotation orientation.

7. The polyhedron spinner device kit of claim 6, wherein said inner sphere is rotatable about said vertical rod for viewing of said geometric shape in a second rotation orientation.

8. The polyhedron spinner device kit of claim 1, wherein said inner sphere is positioned at a center of said geometric shape.

9. The polyhedron spinner device kit of claim 1, wherein said horizontal rod is selectively and detachably supported on a plurality of supporting bars extending from a base.

10. A dual sphere spinner device kit comprising:
a central sphere having a central hole therethrough for mounting to a vertical rod;
a plurality of quadrants, wherein said plurality of quadrants includes eight quadrants; and
a plurality of pegs, wherein said plurality of quadrants are spaced about said central sphere and connectable with said plurality of pegs, and further wherein each one of said eight quadrants is connected to at least three other quadrants by at least three pegs.

11. The dual sphere spinner device kit of claim 10, wherein said central sphere and said plurality of quadrants are rotatable about said vertical rod.

12. A polyhedron spinner device kit comprising:
a plurality of buildable components comprised of a plurality of outer spheres, an inner sphere, and a plurality of pegs;
wherein said inner sphere includes a first central hole extending therethrough, a second hole extending partially therethrough, and a third hole partially extending therethrough;
wherein said plurality of outer spheres comprise a plurality of holes;
wherein said inner sphere is selectively mountable to a horizontal rod with said first central hole or to a vertical rod with said second hole; and
at least one peg connected to said third hole of said inner sphere and to at least one of said plurality of holes of at least one of said plurality of outer spheres for connecting said plurality of outer spheres to said inner sphere to form a geometric shape therearound.

13. The polyhedron spinner device kit of claim 12, wherein said plurality of pegs are insertable into said holes of said plurality of outer spheres to connect at least four of said plurality of outer spheres spaced around said inner sphere to form a tetrahedron.

14. The polyhedron spinner device kit of claim 12, wherein said plurality of pegs are insertable into said holes of said plurality of outer spheres to connect at least six of said plurality of outer spheres to form a hexahedron.

15. The polyhedron spinner device kit of claim 12, wherein said plurality of pegs are insertable into said holes of said plurality of outer spheres to connect at least eight of said plurality of outer spheres to form an octahedron.

16. The polyhedron spinner device kit of claim 12, wherein said plurality of pegs are insertable into said holes of said plurality of outer spheres to connect at least ten of said plurality of outer spheres to form a dodecahedron.

17. The polyhedron spinner device kit of claim 12, wherein said plurality of pegs are insertable into said holes of said plurality of outer spheres to connect at least twenty of said plurality of outer spheres to form an icosahedron.

18. The polyhedron spinner device kit of claim 13, wherein said inner sphere is rotatable about said horizontal rod for viewing of said geometric shape in a first rotation orientation.

19. The polyhedron spinner device kit of claim 18, wherein said inner sphere is rotatable about said vertical rod for viewing of said geometric shape in a second rotation orientation that differs from the first rotation orientation.

20. The polyhedron spinner device kit of claim 13, wherein said inner sphere is positioned at a center of said geometric shape.
